(19) United States
(12) Patent Application Publication
(10) Pub. No.: US 2026/0333525 A1
(43) Pub. Date: Oct. 22, 2026

(54) HOB AND HOB DEVICE

(71) Applicant: BSH Hausgeräte GmbH, Munich (DE)

(72) Inventors: Diego Puyal Puente, Zaragoza (ES); Manuel Fernandez Martinez, Zaragoza (ES); Victor Camañes Vera, Zaragoza (ES); Eduardo Imaz Martinez, Tudela (Navarra) (ES); Jose Manuel Palacios Gasos, Zaragoza (ES); Lucia Herrero Lorente, Zaragoza (ES); Javier Serrano Trullen, Zaragoza (ES); Rosario Romeo Velilla, Zaragoza (ES); Cristina Blan Sanmartin, Huesca (ES)

(21) Appl. No.: 19/108,753

(22) PCT Filed: Jul. 24, 2023
(86) PCT No.: PCT/EP2023/070410

§ 371 Date: Mar. 5, 2025

(30) Foreign Application Priority Data
Sep. 9, 2022 (EP) 22382835.1

(51) Int. Cl. H05B 6/06; H05B 6/12

(52) U.S. Cl. CPC H05B 6/062; H05B 6/1272; H05B 2213/03

(57) ABSTRACT

A cooktop apparatus includes a first heating unit comprising at least two first heating elements, a second heating unit comprising a second heating element arranged between the at least two first heating elements of the first heating unit, a first power supply unit designed to supply power to the first heating unit and for permanent connection to a first power phase of a power supply network, and a second power supply unit designed to supply power to the second heating unit and for permanent connection to a second power phase of the power supply network.

### PRIOR ART

The invention relates to a cooktop apparatus according to the preamble of claim 1 and a cooktop according to claim 13.

A cooktop apparatus comprising at least one heating unit with a plurality of heating elements is known from the prior art, at least one heating element of the plurality of heating elements being able to be operated with power from a power phase of a power supply network. It has already been proposed that the plurality of heating elements has at least one further heating element, which can be operated in a flexible manner as required to heat a placement unit with power from the same power phase of the power supply network in the same way as the heating element already mentioned or with power from a further power phase of the power supply network.

The object of the invention is, although not exclusively, to provide a generic apparatus with improved properties in respect of efficiency. According to the invention the object is achieved by the features of claims 1 and 13, while advantageous configurations and developments of the invention will emerge from the subclaims.

### ADVANTAGES OF THE INVENTION

The invention relates to a cooktop apparatus, in particular an induction cooktop apparatus, with at least one first heating unit, which comprises at least two first heating elements, with at least one second heating unit, which comprises at least one second heating element, with a first power supply unit, which is provided to supply power to the first heating unit and to be connected permanently to a first power phase of a power supply network, and with a second power supply unit, which is provided to supply power to the second heating unit and to be connected permanently to a second power phase of the power supply network.

It is proposed that at least the second heating element is arranged between the at least two first heating elements.

Such a configuration results in a particularly efficient and/or compact configuration of a cooktop device. Cost and/or performance and/or operating efficiency can also be enhanced. Such an arrangement of heating elements allows a “superboost” heating function for at least one placement unit in an efficient manner, at low cost and/or compactly and/or simply and/or minimizing material and/or part outlay. It also improves flexibility in respect of possible placement configurations for at least the placement unit.

In particular the cooktop apparatus is part, specifically a subassembly, of a cooktop. The cooktop apparatus could be configured at least partially as a resistance cooktop apparatus and/or preferably as an induction cooktop apparatus. The cooktop apparatus can also comprise accessories for the cooktop, for example a sensor unit for placement unit identification and/or external measurement of a temperature of a placement unit and/or a food being cooked. It would also be conceivable for the cooktop apparatus to comprise the entire cooktop. The cooktop is preferably configured as an induction cooktop. The cooktop apparatus and/or cooktop is/are provided for use and/or arrangement in a domestic setting, in particular a kitchen. The cooktop could in turn be part of a cooktop system, it being possible for the cooktop system to comprise a plurality of units and/or apparatuses, which can be used to treat and/or process food. For example the cooktop system could also have at least one extraction unit and/or at least the sensor unit and/or further sensor units, in particular at least one temperature sensor, which could be provided for location in the placement unit and/or in the food being cooked, for example in the form of a skewer. Alternatively the cooktop apparatus can also be configured as a kit and/or assembly for different types of cooktop, which may differ from one another in particular in respect of number of inductors and/or size.

The cooktop can have at least one placement plate. The placement plate is configured in particular as a plate-type unit, which is provided for the placement at least of the placement unit and/or for the lying on of at least one food, in particular the food being cooked. The placement plate could be configured for example as a worktop, in particular as a kitchen worktop, or as a sub-region of at least one worktop, in particular at least one kitchen worktop, in particular of the cooktop system. Alternatively and/or additionally the placement plate could be configured as a cooktop plate. The placement plate configured as a cooktop plate could in particular form at least part of a cooktop outer housing and, advantageously together with at least one outer housing unit, to which the placement plate configured as a cooktop plate could be connected in at least one mounted state, could at least largely form the cooktop outer housing. The placement plate is preferably made of a non-metallic material. The placement plate could be configured at least partially or at least largely of glass and/or glass ceramic and/or Neolith and/or Dekton and/or wood and/or marble and/or stone, in particular natural stone, and/or laminate and/or plastic and/or ceramic material and/or a composite material. The expression “largely” means at least 55%, advantageously at least 65%, preferably at least 75%, particularly preferably at least 85% and particularly advantageously maximum 95% of a percentage by volume and/or mass. In the present document position references, such as “below” or “above” relate to a mounted state of the placement plate, unless specifically stated otherwise.

The placement unit can comprise a small household appliance and/or the cooking utensil. The small household appliance could be for example a coffee machine and/or a toaster and/or a water heater and/or a mixer and/or a whisk. In particular the small household appliance is portable and/or can be positioned and/or arranged flexibly in relation to the cooktop. The small household appliance could advantageously be supplied at least partially inductively with energy when placed on the placement plate. The cooking utensil can be configured for example as a pot and/or pan and/or roasting pan. If the cooktop apparatus is configured as an induction cooktop apparatus, the placement unit could be supplied at least partially inductively with energy at least for heating when placed on the placement plate. It would also be conceivable for the placement unit to comprise a base unit, which is provided for placement below the cooking utensil and/or small household appliance. The base unit can advantageously be arranged between the placement plate and the cooking utensil and/or the small household appliance. In particular the placement unit can be arranged on the placement plate in a cooking surface region of the cooktop. The cooking surface region is preferably configured at least partially and preferably wholly as a variable cooking surface region. A “variable cooking surface region” refers to a cooking surface region, which is provided to form at least one heating zone tailored to at least the placed placement unit, in particular the small household appliance and/or the cooking utensil and/or the base unit. The variable cooking surface region advantageously differs from a cooking surface in which heating zones are permanently predetermined, in particular by markings on the cooking surface.

At least the first heating unit and/or at least the second heating unit can be provided to heat the placement unit in the cooking surface region in at least one operating state. The first heating unit is advantageously configured as a first induction heating unit and the at least two first heating elements as at least two first inductors. The second heating unit is preferably configured as a second induction heating unit and the second heating element as at least one second inductor. A “heating unit” refers to a unit which is provided, at least in one operating state, to transfer electrical energy at least largely to the placement unit, preferably through at least the kitchen worktop, and/or to convert electrical energy to heat, in order in particular to heat at least the placed placement unit, preferably through at least the placement plate. In particular the heating unit is provided, in at least one operating state in which the heating unit is connected to at least one power supply unit of the cooktop apparatus, to transfer a power of at least 100 W, in particular at least 500 W, advantageously at least 1000 W, preferably at least 2000 W. An “inductor” here refers to an element which has at least one induction coil and/or is configured as an induction coil and is provided, in at least one operating state, to supply energy, in particular in the form of a magnetic alternating field, to at least one receiving element, in particular at least the placement unit. The receiving element could be configured as a metal heating means, in particular as an at least partially ferromagnetic heating means, for example as a ferromagnetic bottom of the placement unit, in particular of the cooking utensil and/or the base unit and/or the small household appliance, in which, when the heating unit is in an operating mode, eddy currents and/or magnetic polarization reversal effects are produced by the inductors and converted to heat. Alternatively or additionally the placement unit could have at least one secondary coil as a receiving element to receive the energy supplied by the inductor and/or a further inductor.

The first power supply unit, which when the cooktop is in a mounted state is connected permanently to the first power phase of the power supply network, is preferably provided solely to supply power to the first heating unit. In particular in the mounted state and in at least one operating state the first power supply unit supplies the first heating unit with power from the first power phase. The second power supply unit, which when the cooktop is in the mounted state is connected permanently to the second power phase of the power supply network, is advantageously provided solely to supply power to the second heating unit. In particular in the mounted state and in at least one operating state, preferably in at least the already mentioned operating state, the second power supply unit supplies the second heating unit with power from the second power phase. The cited power phases of the cited power supply network are individual phases of a conventional power supply network for supplying domestic users, preferably German domestic users. In particular an electrical power per power phase, in particular of the first power phase and/or second power phase, is limited.

It would be conceivable for the cooktop apparatus to have further heating units, specifically at least one third heating unit and at least one third power supply unit to supply power to the third heating unit. The third power supply unit could supply the third heating unit with power from the first power phase and/or the second power phase and/or at least one third power phase of the power supply network and in particular be provided for permanent connection to the first power phase and/or the second power phase and/or the third power phase.

The second heating element of the second heating unit could also be referred to as an intermediate heating element. In particular the second heating element is provided to heat at least one region between the at least two first heating elements of the first heating unit. The second heating element is advantageously arranged directly between the two first heating elements. The at least two first heating elements are preferably arranged next to the second heating element. The second heating element could be arranged at least partially at a distance from at least one of the two first heating elements. For example a distance between the second heating element and at least one of the first heating elements could be at least 1 mm, advantageously at least 10 mm and advantageously at least 30 mm. Alternatively it would also be conceivable for the second heating element to be arranged at least partially in contact with at least one of the first heating elements.

The at least two first heating elements of the first heating unit could differ in respect of intended power consumption and/or intended power output and/or in respect of their configuration, for example geometry and/or size. The at least two heating elements of the first heating unit are preferably configured identically to one another. The second heating element of the second heating unit could also differ from at least one of the at least two first heating elements, advantageously from both the two first heating elements, for example in respect of intended power consumption and/or intended power output and/or in respect of configuration, for example geometry and/or size. The second heating element is preferably configured identically to at least one of the at least two first heating elements, advantageously to both the two first heating elements. The formulation “identical objects” here refers to objects that advantageously have the same structure and/or shape and/or outer contour and/or construction and/or at least largely and preferably totally the same material composition, but can differ at least partially in respect of functionality, internal structure, arrangement relative to another object and/or alignment in relation to another object. The identical objects are however preferably identical apart from manufacturing tolerances and/or in the area of standard tolerances.

The second heating element and at least one of the first heating elements could preferably be aligned respectively with their longitudinal sides parallel to one another and be arranged next to one another, in particular if the heating elements have a rectangular outer contour when viewed from above. Also at least one longitudinal side of the second heating element could face a narrow and/or wide side of at least one of the first heating elements. A longitudinal side of the second heating element is preferably arranged parallel to a longitudinal side of at least a first of the first heating elements and a further longitudinal side of the second heating element opposite the longitudinal side is preferably arranged parallel to a narrow and/or wide side of at least a second of the first heating elements.

In the present document numerical words, for example “first” and “second”, preceding specific terms are only used to differentiate objects and/or for assignment between objects and do not imply any overall number and/or sequence of said objects. In particular a “second” object does not necessary imply the existence of a “first” object. “Provided” here and in the following means specifically programmed, designed and/or equipped. That an object is provided for a specific function means that the object satisfies and/or performs said specific function in at least one application and/or operating state.

It is further proposed that at least one heating element of the first heating elements and the second heating element are provided to both heat at least one placement unit in at least one operating mode. This enhances efficiency in respect of heating at least one placement unit and offers a “superboost” mode. This in turn enhances user friendliness and/or user convenience and/or a user experience.

The placement unit is advantageously the placement unit mentioned above. In particular at least the operating mode is part of an operating state, preferably the operating state mentioned above. The cited operating mode is preferably a “superboost” operating mode. In “superboost” operating mode an available heating power of at least 3700 W, advantageously at least 4000 W and particularly preferably at least 4500 W can be supplied for at least the placement unit. In “superboost” operating mode the available power per power phase of the power supply network, specifically the first power phase and at least the second power phase, can be combined to heat the placement unit.

It is also proposed that the first power supply unit has at least one first rectifier and the second power supply unit has at least one second rectifier. This enhances efficiency in respect of working and/or cost and/or operating and/or power and/or heating efficiency. The first rectifier and the second rectifier could be configured differently. The two rectifiers are preferably configured identically to one another, irrespective of manufacturing tolerances.

To avoid any overheating of at least the first rectifier, it is proposed that the first power supply unit has at least one further first rectifier, which is connected parallel to the first rectifier. This means there is no need for a costly and/or complex rectifier and enhances efficiency in respect of working and/or operating and/or power and/or heating and/or cost efficiency. It also optimizes the construction of a cooktop apparatus. To avoid any overheating of at least the second rectifier, the second power supply unit advantageously has a further second rectifier, which is connected parallel to the second rectifier.

The first power supply unit preferably comprises at least one first inverter unit with at least two first inverters, each connected to the first rectifier. This enhances efficiency in respect of connection and/or actuation and/or power supply.

In particular the first rectifier unit forms a totality of all first inverters. An “inverter” refers to a unit which, in at least one operating state, in particular at least one operating mode, supplies an, in particular high-frequency, alternating current, in particular with a frequency of at least 10 kHz, preferably at least 20 kHz and in particular maximum 100 kHz, for at least one further unit, preferably for at least one of the heating units of the cooktop apparatus, advantageously the first heating unit and/or the second heating unit. In particular the inverter can have at least two inverter switching elements. An “inverter switching element” here refers to an element provided to establish and/or break an electrically conducting connection between two points, in particular contacts of the switching element. The switching element preferably has at least one control contact, by way of which it can be connected. In particular the switching element is configured as a semiconductor switching element, in particular as a transistor, for example a metal-oxide-semiconductor field-effect transistor (MOSFET) or organic field-effect transistor (OFET), advantageously as a bipolar transistor with a preferably insulated gate electrode (IGBT). The inverter switching elements can also be made at least partially of a semiconductor material, for example silicon, silicon carbide and/or gallium nitride and/or another semiconductor material that appears expedient to the person skilled in the art. Alternatively it is conceivable for the inverter switching element to be configured as a mechanical and/or electromechanical switching element, in particular as a relay.

In the operating state the at least two first inverters preferably perform a frequency conversion and in particular convert a low-frequency alternating current voltage at the input to a high-frequency alternating current voltage at the output. In particular the low-frequency alternating current voltage has a frequency of maximum 100 Hz. The high-frequency alternating current voltage preferably has a frequency of at least 1000 Hz. The first inverter unit can be connected to a control unit of the cooktop apparatus and be able to be controlled by the control unit by means of control signals.

It is further proposed that the second power supply unit comprises at least one second inverter unit with at least one second inverter, which is connected to the second rectifier. This further enhances efficiency in respect of connection and/or actuation and/or power supply. In the operating state the second inverter preferably performs a frequency conversion and in particular converts a low-frequency alternating current voltage at the input to a high-frequency alternating current voltage at the output. In particular the low-frequency alternating current voltage has a frequency of maximum 100 Hz. The high-frequency alternating current voltage preferably has a frequency of at least 1000 Hz. The second inverter unit can be connected to the control unit and be able to be controlled by the control unit by means of control signals. The second heating element is advantageously connected to the second inverter.

It would be conceivable for the at least two first heating elements to be connected to the same inverter of the first inverter unit, together with at least one of the at least two first inverters. Separate connection of each heating element of the first heating unit to an inverter of the first inverter unit results in particularly efficient connection and/or actuation and/or power supply. It also allows optimized and/or simpler maintenance and/or parts replacement.

A first heating element of the two first heating elements is advantageously connected to a first inverter of the two first inverters. A second heating element of the two first heating elements can be connected to a second inverter of the two first inverters. The second inverter unit can also comprise further second inverters, specifically at least one further second inverter, in particular if the second heating unit has further second heating elements, specifically at least one further second heating element. Each heating element of the second heating unit can be connected separately to an inverter of the second inverter unit. In particular the second inverter unit forms a totality of all second inverters.

To configure a construction as well as a connection and/or arrangement of electronic parts more efficiently, it is proposed that the cooktop apparatus comprises at least one first power board, on which the first power supply unit is arranged, and a second power board, on which the second power supply unit is arranged.

A “power board” refers to a support for electrical and/or electronic parts. At least the first inverter unit and at least the first rectifier are arranged on the first power board. The first power board can also have further units and/or elements in particular of the first power supply unit, for example switching elements and/or electrical resistances and/or AC power controllers and/or capacitors and/or the like. At least the second inverter unit and at least the second rectifier are arranged on the second power board. The second power board can also have further units and/or elements in particular of the second power supply unit, for example switching elements and/or electrical resistances and/or AC power controllers and/or capacitors and/or the like.

It is also proposed that the first heating unit has a plurality of further first heating elements, at least one of the first heating elements being arranged in a first row with the further first heating elements. This increases flexibility when positioning placement units and efficiency when heating placement units. At least the first row preferably forms a flexible heating zone for at least the placement unit. The plurality of further first heating elements can preferably comprise for example at least two further first heating elements, advantageously at least three further first heating elements and preferably at least five further first heating elements. The first row can comprise and/or be made up in total of at least three first heating elements of the first heating unit, advantageously at least four first heating elements of the first heating unit and preferably at least five first heating elements of the first heating unit. The first row is preferably formed by at least one of the first heating elements and at least three further first heating elements.

It is also proposed that the second heating unit has a plurality of further second heating elements, at least one of the first heating elements being arranged between the second heating element and at least one further second heating element of the plurality of further second heating elements. This further increases flexibility when positioning placement units and efficiency when heating placement units. Such an arrangement of heating elements allows a “superboost” heating function to be achieved in an efficient manner for at least one placement unit, at low cost and/or compactly and/or simply and/or minimizing material and/or part outlay.

At least one of the first heating elements, which is arranged between the second heating element and at least the further second heating element of the plurality of second heating elements, could also be referred to as an intermediate heating element. The at least one heating element of the first heating elements is advantageously arranged directly between the second heating element and the further second heating element. At least two further heating elements of the plurality of further second heating elements are preferably arranged next to the at least one heating element of the first heating elements. At least the one heating element of the first heating elements could be arranged at least partially at a distance from the second heating element and/or at least the further second heating element. For example a distance between the second heating element and/or at least the further second heating element and the at least one heating element of the first heating elements could be for example at least 1 mm, advantageously at least 10 mm and advantageously at least 30 mm. Alternatively it would also be conceivable for the at least one heating element of the first heating elements to be arranged at least partially in contact with the second heating element and/or at least the further second heating element.

The at least one heating element of the first heating elements and the second heating element could each be aligned with their longitudinal sides preferably parallel to one another and be arranged next to one another, in particular if the heating elements have a rectangular outer contour when viewed from above. Also at least one longitudinal side of the at least one heating element of the first heating elements could face a narrow and/or wide side of the further second heating element. A longitudinal side of the at least one heating element of the first heating elements is preferably aligned parallel to a longitudinal side of the second heating element and a further longitudinal side of the at least one heating element of the first heating elements opposite the longitudinal side is preferably aligned parallel to a narrow and/or wide side of the further second heating element.

The plurality of further second heating elements can comprise for example at least two further second heating elements, advantageously at least three further second heating elements and preferably at least five further second heating elements. It is further proposed that the plurality of further second heating elements are arranged in a second row. This further increases flexibility when positioning placement units and efficiency when heating placement units. At least the second row preferably forms a flexible heating zone for at least the placement unit. The second row can comprise and/or be made up in total of at least three further second heating elements of the second heating unit, advantageously at least four further second heating elements of the second heating unit and preferably at least five further second heating elements of the second heating unit.

It is further proposed that the first row and second row are aligned parallel to one another and the at least one second heating element is arranged between the two rows. This allows and/or results in a compact and efficient arrangement of heating elements and heating of placement units.

At least the one heating element of the first heating elements and at least the second heating element are arranged in a region between the first row and the second row. The one heating element of the first heating elements and at least the second heating element are preferably arranged parallel to one another. “Parallel” refers to the alignment of a direction relative to a reference direction, in particular in a plane, where the direction deviates by less than 8°, advantageously less than 5° and particularly advantageously less than 2° from the reference direction.

The cooktop apparatus and/or cooktop here are not restricted to the application and embodiment described above. In particular the cooktop apparatus and/or cooktop can have a different number of individual elements, parts, units and method steps from the number cited herein to comply with a mode of operation described herein. Also for the value ranges cited in the present document values lying within the cited limits should also be deemed to be disclosed and able to be used as required.

### DRAWINGS

Further advantages will emerge from the description of the drawings that follows. The drawings show an exemplary embodiment of the invention. The drawings, description and claims contain numerous features in combination. The person skilled in the art will expediently also consider the features individually and combine them in useful further combinations. In the drawings:

FIG. 1 shows a cooktop with a cooktop apparatus configured as an induction cooktop apparatus,

FIG. 2 shows a plan view of an placement plate of the cooktop to clarify an arrangement of a first heating unit and a second heating unit of the cooktop apparatus below the placement plate,

FIG. 3 shows a possible positioning of a placement unit for heating by means of the first heating unit and the second heating unit,

FIG. 4 shows a further possible positioning of the placement unit,

FIG. 5 shows a further possible positioning of the placement unit and

FIG. 6 shows a schematic electrical circuit diagram of the cooktop apparatus, with a first power supply unit and a second power supply unit.

### DESCRIPTION OF THE EXEMPLARY EMBODIMENT

The figures below are schematic drawings that are not to scale. Only one of objects shown multiple times is provided with a reference character, unless otherwise specified.

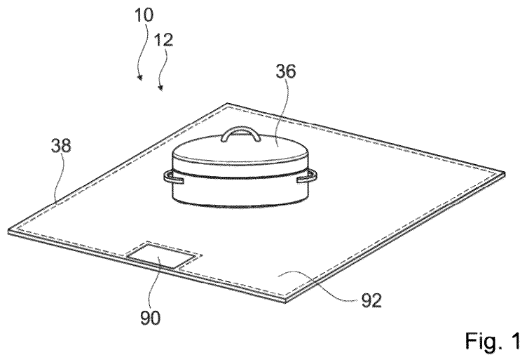

FIG. 1 shows a cooktop 10 configured as an induction cooktop. The cooktop 10 comprises a placement plate 38, on which at least one placement unit 36 can be placed and/or arranged. In this exemplary configuration the placement unit 36 is configured as a cooking utensil. Alternatively and/or additionally the placement unit 36 can be configured as a small household appliance and/or a base unit. The placement unit 36 can be arranged on the placement plate 36 in a cooking surface region 92 of the cooktop 10. The cooking surface region 92 here is a variable cooking surface region. The cooktop 10 also has at least one operator interface 90 for control and/or operation by at least one operator and/or for outputting and/or inputting information and/or operating parameters to and/or by the operator. The cooktop 10 has a cooktop apparatus 12. The cooktop apparatus 12 is configured as an induction cooktop apparatus.

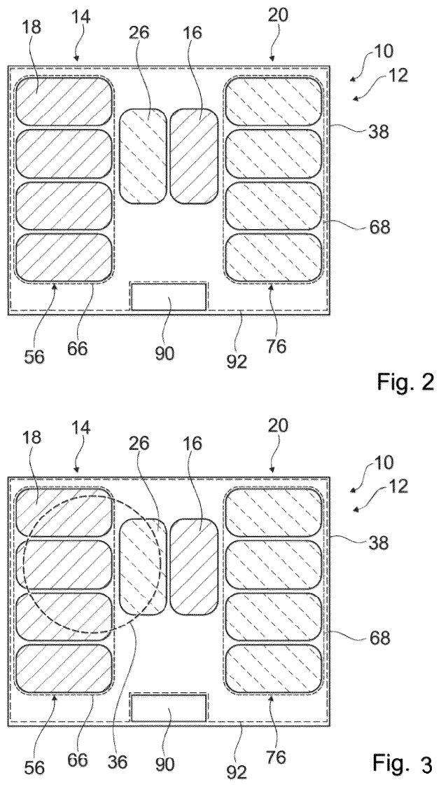

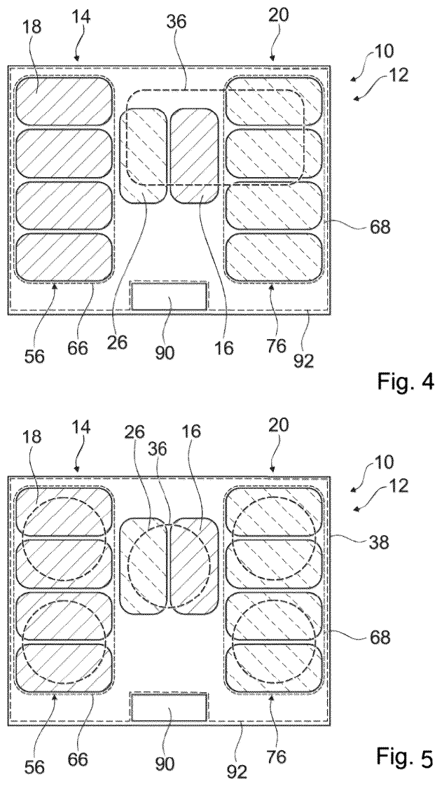

To heat at least the placement unit 36 the cooktop apparatus 12 has at least one first heating unit 14 and at least one second heating unit 20. FIGS. 2 to 6 show the respective arrangements of the first heating unit 14 and the second heating unit 20. The first heating unit 14 has at least two first heating elements 16, 18. The first heating unit 14 here has a plurality of further first heating elements 56, at least one of the first heating elements 16, 18 being arranged in a first row 66 with the further first heating elements 56. The second first heating element 18 here is arranged in the first row 66 with the further first heating elements 56.

The second heating unit 20 has at least one second heating element 26. At least the second heating element 26 is arranged between the at least two first heating elements 16, 18. The second heating unit 20 also has a plurality of further second heating elements 76, at least one of the first heating elements 16, 18 being arranged between the second heating element 26 and at least one further second heating element 76 of the plurality of further second heating elements 76. The first heating element 16 here is arranged between the second heating element 26 and at least one further second heating element 76 of the plurality of further second heating elements 76. The plurality of further second heating elements 76 are arranged in a second row 68. In this exemplary configuration the first row 66 and second row 68 are aligned parallel to one another. The at least second heating element 26 is arranged between the two rows 66, 68. The first heating element 16 of the at least two first heating elements 16, 18 is also arranged together with the second heating element 26 between the two rows 66, 68. The second heating element 26 and the first heating element 16 of the at least two first heating elements 16, 18 are arranged next to one another.

All the heating elements 16, 18, 56 of the first heating unit 14 are configured identically to one another. All the heating elements 26, 76 of the second heating unit 20 are also configured identically to one another. All the heating elements 16, 18, 56 of the first heating unit 14 here are configured identically to all the heating elements 26, 76 of the second heating unit 20, in respect of at least one size and/or shape and/or geometry.

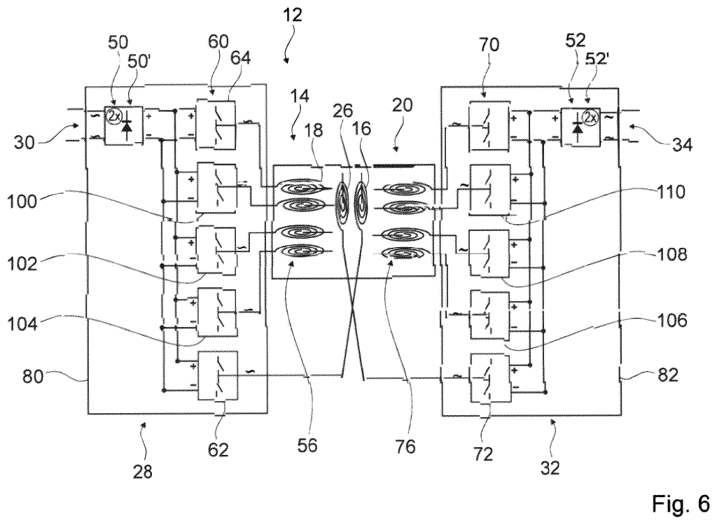

FIG. 6 shows a schematic electrical circuit diagram of the cooktop apparatus 12. The cooktop apparatus 12 has a first power supply unit 28, which is provided to supply power to the first heating unit 14 and for permanent connection to a first power phase 30 of a power supply network. To supply power to the second heating unit 20 the cooktop apparatus 12 has a second power supply unit 32. The second power supply unit 32 is provided for permanent connection to a second power phase 34 of the power supply network. The cited power phases 30, 34 of the cited power supply network are individual phases of a conventional power supply network for supplying domestic users, preferably German domestic users.

The cooktop apparatus 12 has at least one first power board 80, on which the first power supply unit 28 is arranged. The cooktop apparatus 12 also has a second power board 82, on which the second power supply unit 32 is arranged.

The first power supply unit 28 has at least one first rectifier 50 and the second power supply unit 32 has at least one second rectifier 52. In this exemplary configuration, to avoid any overheating of at least the first rectifier 50, the first power supply unit 28 has at least one further first rectifier 50′, which is connected parallel to the first rectifier 50. To avoid any overheating of at least the second rectifier 52, the second power supply unit 32 has at least one further second rectifier 52′, which is connected parallel to the second rectifier 52. Alternatively just one rectifier 50, 52 could be present for each power supply unit 28, 32.

FIG. 6 shows that the first power supply unit 28 comprises at least one first inverter unit 60 with at least two first inverters 62, 64, each connected to the first rectifier 50. The first inverter unit 60 has further first inverters 100, 102, 104. The first inverter unit 60 here comprises exactly the same number of first inverters as the first heating unit 14 has first heating elements. Each heating element 16, 18, 56 of the first heating unit 14 is connected separately to its own first inverter 62, 64, 100, 102, 104 of the first inverter unit 60. The first inverter unit 60 forms the totality of all first inverters 62, 64, 100, 102, 104.

The second power supply unit 32 has at least one second inverter unit 70 with at least one second inverter 72, which is connected to the second rectifier 52. The second inverter unit 70 has further second inverters 106, 108, 110. The second inverter unit 72 here comprises exactly the same number of second inverters as the second heating unit 20 has second heating elements. Each heating element 26, 76 of the second heating unit 20 is connected separately to its own second inverter 72, 106, 108, 110 of the second inverter unit 72. The second inverter unit 72 forms the totality of all second inverters 72, 106, 108, 110.

FIGS. 3 to 5 show possible placement positions of placement units 36 on the placement plate 38. In at least one operating mode, specifically in at least one “superboost” operating mode, at least one heating element 16, 18 of the first heating elements 16, 18 and at least the second heating element 26 are provided together to heat at least the placement unit 36. The known power limit per power phase 30, 34 of the power supply network means that more efficient heating of the placement unit 36 can be achieved by combining the powers of the at least two power phases 30, 34, so the placement unit 36 is heated in “superboost” operating mode.

### REFERENCE CHARACTERS

10 Cooktop
12 Cook top apparatus
14 Heating unit
16 Heating elements
18 Heating elements
20 Heating unit
26 Heating element
28 Power supply unit
30 Power phase
32 Power supply unit
34 Power phase
36 Placement unit
38 Placement plate
50 Rectifier
52 Rectifier
56 Heating element
60 Inverter unit
62 Inverter
64 Inverter
66 Row
68 Row
70 Inverter unit
72 Inverter
76 Heating element
80 Power board
82 Power board
90 Operator interface
92 Cooking surface region
100 Inverter
102 Inverter
104 Inverter
106 Inverter
108 Inverter
110 Inverter

1-13. (canceled)

14. A cooktop apparatus, comprising:
a first heating unit comprising at least two first heating elements;
a second heating unit comprising a second heating element arranged between the at least two first heating elements of the first heating unit;
a first power supply unit designed to supply power to the first heating unit and for permanent connection to a first power phase of a power supply network; and
a second power supply unit designed to supply power to the second heating unit and for permanent connection to a second power phase of the power supply network.

15. The cooktop apparatus of claim 14, constructed in a form of an induction cooktop apparatus.

16. The cooktop apparatus of claim 14, wherein at least one of the at least two first heating elements of the first heating element and the second heating element of the second heating unit are provided to both heat a placement unit in an operating mode.

17. The cooktop apparatus of claim 14, wherein the first power supply unit comprises a first rectifier and the second power supply unit comprises a second rectifier.

18. The cooktop apparatus of claim 17, wherein the first power supply unit comprises a further first rectifier, which is connected parallel to the first rectifier and designed to avoid any overheating of the first rectifier.

19. The cooktop apparatus of claim 17, wherein the first power supply unit comprises a first inverter unit which comprises at least two first inverters, each of the at least two first inverters being connected to the first rectifier.

20. The cooktop apparatus of claim 17, wherein the second power supply unit comprises a second inverter unit which comprises a second inverter, which is connected to the second rectifier.

21. The cooktop apparatus of claim 19, wherein the at least two first heating elements of the first heating unit are connected separately to the at least two first inverters of the first inverter unit, respectively.

22. The cooktop apparatus of claim 14, further comprising:
a first power board, on which the first power supply unit is arranged; and
a second power board, on which the second power supply unit is arranged.

23. The cooktop apparatus of claim 14, wherein the first heating unit comprises a plurality of further first heating elements, with at least one of the first heating elements being arranged in a first row with the further first heating elements.

24. The cooktop apparatus of claim 14, wherein the second heating unit comprises a plurality of further second heating elements, with at least one of the first heating elements of the first heating unit being arranged between the second heating element and at least one further second heating element of the plurality of further second heating elements of the second heating unit.

25. The cooktop apparatus of claim 24, wherein the first heating unit comprises a plurality of further first heating elements, with at least one of the first heating elements being arranged in a first row with the further first heating elements, wherein the plurality of further second heating elements of the second heating unit are arranged in a second row.

26. The cooktop apparatus of claim 25, wherein the first row and second row are aligned parallel to one another, said second heating element being arranged between the first and second rows.

27. A cooktop, in particular an induction cooktop, the cooktop comprising a cooktop apparatus including a first heating unit which comprises at least two first heating elements, a second heating unit comprising a second heating element arranged between the at least two first heating elements of the first heating unit, a first power supply unit designed to supply power to the first heating unit and for permanent connection to a first power phase of a power supply network, and a second power supply unit designed to supply power to the second heating unit and for permanent connection to a second power phase of the power supply network.

28. The cooktop of claim 27, wherein the first power supply unit comprises a first rectifier and the second power supply unit comprises a second rectifier.

29. The cooktop of claim 28, wherein the first power supply unit comprises a further first rectifier, which is connected parallel to the first rectifier and designed to avoid any overheating of the first rectifier.

30. The cooktop of claim 28, wherein the first power supply unit comprises a first inverter unit which comprises at least two first inverters, each of the at least two first inverters being connected to the first rectifier.

31. The cooktop of claim 28, wherein the second power supply unit comprises a second inverter unit which comprises a second inverter, which is connected to the second rectifier.

32. The cooktop of claim 30, wherein the at least two first heating elements of the first heating unit are connected separately to the at least two first inverters of the first inverter unit, respectively.

33. The cooktop of claim 27, wherein the first heating unit comprises a plurality of further first heating elements, with at least one of the first heating elements being arranged in a first row with the further first heating elements, and wherein the second heating unit comprises a plurality of further second heating elements arranged in a second row which is aligned parallel to the first row, at least one of the first heating elements of the first heating unit being arranged between the second heating element and at least one further second heating element of the plurality of further second heating elements of the second heating unit.
